(19) United States
(12) Patent Application Publication
(10) Pub. No.: US 2025/0260917 A1
(43) Pub. Date: Aug. 14, 2025

(54) CONSTRUCTION FOR MOUNTING AN ELECTRODYNAMIC TRANSDUCER IN A PASSENGER COMPARTMENT OF A MOTOR VEHICLE

(71) Applicant: TREVES PRODUCTS, SERVICES & INNOVATION, Issy-Les-Moulineaux (FR)

(72) Inventors: Eric BRILLON, Issy-Les-Moulineaux (FR); Arnaud DUVAL, Issy-Les-Moulineaux (FR); Guillaume CRIGNON, Issy-Les-Moulineaux (FR); Joel TANDART, Issy-Les-Moulineaux (FR)

(21) Appl. No.: 18/856,630

(22) PCT Filed: Apr. 13, 2023
(86) PCT No.: PCT/EP2023/059695

§ 371 Date: Oct. 14, 2024

(30) Foreign Application Priority Data
Apr. 14, 2022 (FR) 2203485

(51) Int. Cl. H04R 1/02; H04R 7/04; H04R 31/00

(52) U.S. Cl. CPC H04R 1/025; H04R 7/04; H04R 31/006; H04R 2499/13

(57) ABSTRACT

The invention relates to an construction (1) for mounting an electrodynamic transducer in an interior compartment of a motor vehicle, said construction comprising a plate (6) having a vibrating structure, at least one electrodynamic transducer (3) attached under said plate, a decoupling frame (4) of increasing stiffness, and a vehicle floor pan (2) and, between said decoupling frame and said floor pan, a rigid holding frame (7) that receives said decoupling frame, a plurality of feet (8) for the base of said holding frame, delimiting a main cavity (9), a porous decoupling and absorption layer (10) and an adjoining cavity (11) extending around said feet and communicating with said main cavity through the spaces (12) between said feet.

The invention concerns an construction for mounting an electrodynamic transducer in an interior compartment of a motor vehicle.

A construction is known for mounting an electrodynamic transducer in an interior compartment of a motor vehicle, such as a passenger compartment or luggage compartment, said construction comprising upon directing downwards:
a plate having a vibrating structure, with a Young's modulus of between 10⁸ and 10⁹ Pa,
at least one electrodynamic transducer attached under said plate, so as to enable the emission of a sound signal, such as music, within the passenger compartment of said vehicle,
a frame for decoupling said plate, that is made of elastically compressible foam, said plate being peripherally fixed to said frame,
a floor pan of said vehicle.

The use of a transducer attached to a vibrating plate, instead of a loudspeaker, allows in particular to save space and weight in the vehicle.

However, a construction as described hereinabove:
does not allow optimum transmission of low frequencies within the passenger compartment,
does not provide good insulation against vehicle rolling noise.

The aim of the invention is to overcome these drawbacks.

To this end, the invention proposes a construction for mounting an electrodynamic transducer in an interior compartment of a motor vehicle, said construction comprising upon directing downwards:
a plate having a vibrating structure, with a Young's modulus of between 10⁸ and 10⁹ Pa,
at least one electrodynamic transducer attached under said plate,
a frame for decoupling said plate, that is made of elastically compressible foam, said plate being peripherally fixed to said frame,
a floor pan of said vehicle,
   said construction also having the following features:
said decoupling frame has increasing stiffness upon distancing from said plate,
it further comprises, successively interposed from top to bottom and between said decoupling frame and said floor pan:
   a rigid holding frame receiving said decoupling frame, said holding frame having a Young's modulus of between 10⁸ and 10⁹ Pa,
   a plurality of feet for the base of said holding frame, said feet having a Young's modulus of between 10⁵ and 10⁶ Pa, said feet and frames delimiting a main cavity extending under said plate,
   a porous decoupling and absorption layer receiving said feet, said layer being elastically compressible and of open porosity, the Young's modulus of said layer being between 10⁴ and 10⁵ Pa,
   an adjoining cavity extending around said feet and communicating with said main cavity through the spaces between the feet, so as to define an extended cavity.

In this description, the terms used for positioning in space (top, bottom, upper, vertical, under, above, etc.) are taken to refer to the construction in place in the vehicle.

With the proposed arrangement:
the fact that the decoupling frame has increasing stiffness upon distancing from the plate, enables vertical vibration decoupling of the plate while holding it firmly in place to limit oscillations in other directions,
the holding frame acts as a reinforcement for the decoupling frame, so as to keep it at best in its unstressed geometry,
the feet allow to support the decoupling frame while helping to minimize the transmission of vibrations to the floor pan,
the open-porosity porous layer, combined with the air space contained in the main cavity between the plate and the sheet, provides, according to a “double-wall” principle, acoustic insulation against rolling noise; in addition, the porous layer helps to decouple the plate,
the presence of the adjoining cavity allows to define the extended cavity which, because of its large size, is ideal for optimizing low-frequency reproduction.

Further features and advantages of the invention will become apparent from the following description, made with reference to the attached figures, in which:

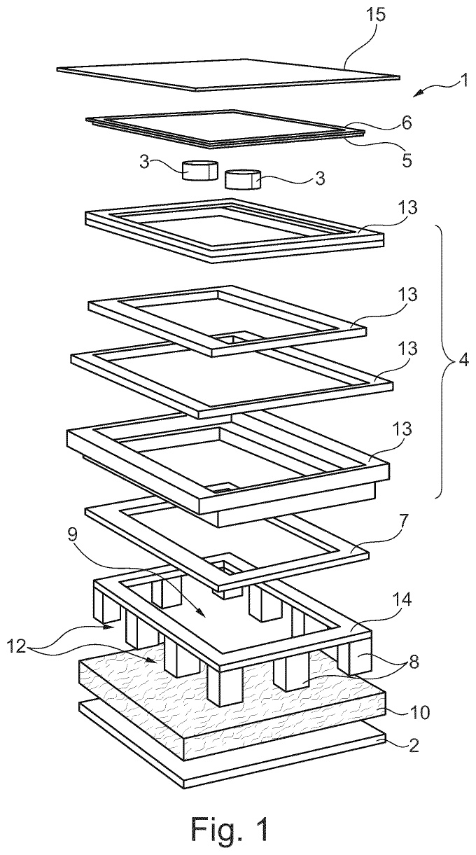

FIG. 1 is a partial schematic exploded perspective view of a construction according to one embodiment,

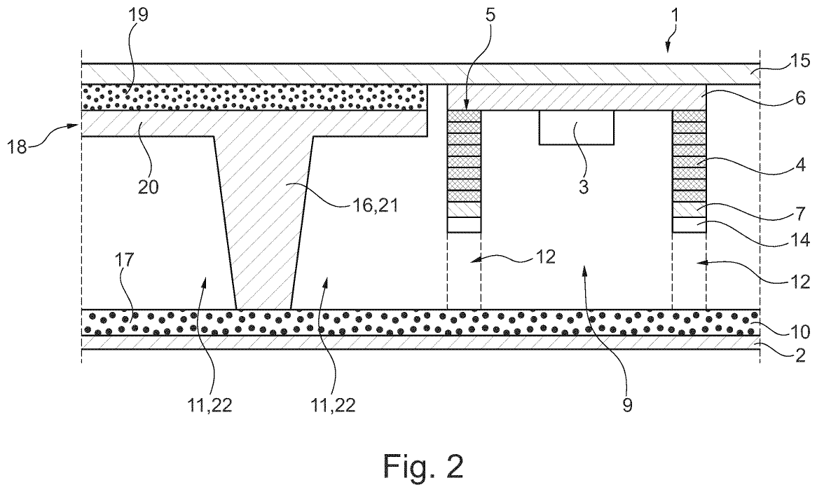

FIG. 2 is a partial schematic view, in vertical section between two feet, of the construction shown in FIG. 1, according to one embodiment.

With reference to the figures, a construction 1 for mounting an electrodynamic transducer in an interior compartment of a motor vehicle is described, said construction comprising upon directing downwards:
a plate 6 having a vibrating structure, with a Young's modulus of between 10⁸ and 10⁹ Pa,
at least one electrodynamic transducer 3 attached under said plate,
a decoupling frame 4 for said plate, that is made of elastically compressible foam, said plate being fixed-for example by gluing-by its periphery 5 to said frame,
a pan 2 for the floor of said vehicle,
   said construction also having the following features:
said decoupling frame has increasing stiffness upon distancing from said plate,
it further comprises, interposed successively from top to bottom and between said decoupling frame and said floor pan:
   a rigid holding frame (7) receiving said decoupling frame, said holding frame having a Young's modulus of between 10⁸ and 10⁹ Pa,
   a plurality of feet 8 for the base of said holding frame, said feet having a Young's modulus of between 10⁵ and 10⁶ Pa, said feet and frames delimiting a main cavity 9 extending under said plate,
   a porous decoupling and absorption layer 10 receiving said feet, said layer being elastically compressible and of open porosity—being made of foam or felt, for example—, the Young's modulus of said layer being between 10⁴ and 10⁵ Pa,
   an adjoining cavity 11 extending around said feet and communicating with said main cavity through the spaces 12 between said feet, so as to define an extended cavity.

According to various embodiments, the decoupling frame 4 can be made of closed-cell ethylene propylene diene monomer (EPDM) foam and/or open-cell polyurethane foam.

According to the embodiment shown, the decoupling frame 4 has a discontinuously varying stiffness, said frame comprising a plurality of elementary decoupling frames 13 made of elastically compressible foam stacked one on top of the other, the Young's modulus of said elementary frames increasing upon distancing from the plate 6 and being between 10⁴ and 10⁶ Pa.

According to a non-represented embodiment, the decoupling frame 4 is made in one piece, said frame having a Young's modulus that increases continuously upon distancing from the plate 6, said modulus being between 10⁴ and 10⁶ Pa.

Such a variation in Young's modulus can be achieved, for example, by increasing the density of the material making up the decoupling frame 4 upon distancing from the plate 6.

According to another embidment not shown, the decoupling frame 4 is made in one piece, said frame having material recesses in the upper part of its thickness to reduce its stiffness (and therefore to reduce its apparent Young's modulus).

10 According to one embodiment, the recesses can be formed by holes made in the upper part of the thickness of the decoupling frame 4, said holes opening out on the upper face of said frame.

According to a further embodiment, the upper face of the decoupling frame 4 has protrusions formed from the material of the frame, the recesses being formed by the spaces between the protrusions.

According to one embodiment, the feet 8 have a relative vertical compressive stress-strain characteristic CC₄₀, measured according to ISO 3386/2 standard in force at the date of filing of the application, greater than 10^{kPa.}

According to the embodiment shown, the feet 8 are associated by their upper ends with a support frame 14, made in particular from the same material as said feet, said support frame receiving the holding frame 7.

In particular, the feet 8 and the support frame 14 can be made in one piece.

In one embodiment, the feet 8 have an open porosity, so as to achieve sound absorption.

In one embodiment, the feet 8 are based on elastically compressible foam flakes bonded together by bi-component fibers comprising a high-temperature meltable core and a lower-temperature meltable sheath, said flakes having been bonded together by melting said sheath.

The advantage of such a material is its high load-bearing capacity (static compressibility at large deformations) and low Young's modulus at small deformations.

Bi-component fibers include, for example, a polyethylene terephthalate (PET) core and a sheath of polyethylene terephthalate modified to lower its melting point.

As shown in FIG. 2, the adjoining cavity 11 comprises a space 22 located between a mat 15 covering the vehicle floor and the pan 2, said mat being spaced from said pan by spacer means 16 decoupled from said pan by a decoupling means 17.

As shown in FIG. 2, the mat 15 also extends over the plate 6.

According to a variant not shown, a cutout can be provided in the mat 15 along the periphery of the plate 6, so as not to create a coupling between the part of said mat surrounding said plate and said plate.

Optionally, a sheet of highly flexible material, such as a non-woven, can be arranged at the cutout, so as to ensure continuity of appearance to the mat 15.

According to the embodiment shown, the mat 15 is laid on a subfloor 18 comprising a layer of compressible foam 19 and a tray 20 made of molded plastic material for receiving said layer, said tray being provided with legs 21 coming from molding and forming spacing means 16, the adjoining cavity 11 comprising the space 22 extending between said legs.

According to the embodiment shown, the decoupling means 17 comprises the porous layer 10 extending into the adjoining cavity 11, the legs 21 being placed on said layer.

In one embodiment, the plate 6 is positioned under a seat so that it cannot be pressed down by passengers' feet.

1. Construction (1) for mounting an electrodynamic transducer in an interior compartment of a motor vehicle, said construction comprising upon directing downwards:
a plate (6) having a vibrating structure with a Young's modulus of between 10⁸ and 10⁹ Pa,
at least one electrodynamic transducer (3) attached under said plate,
a decoupling frame (4) for said plate, that is made of elastically compressible foam, said plate being attached by its periphery (5) to said frame,
a floor pan (2) of said vehicle,
said construction being characterized in that:
said decoupling frame has increasing stiffness upon distancing from said plate,
it further comprises, interposed successively from top to bottom and between said decoupling frame and said floor pan:
a rigid holding frame (7) receiving said decoupling frame, said holding frame having a Young's modulus of between 10⁸ and 10⁹ Pa,
a plurality of feet (8) for the base of said holding frame, said feet having a Young's modulus of between 10⁵ and 10⁶ Pa, said feet and frames delimiting a main cavity (9) extending under said plate,
a porous decoupling and absorption layer (10) receiving said feet, said layer being elastically compressible and of open porosity, the Young's modulus of said layer being between 10⁴ and 10⁵ Pa,
an adjoining cavity (11) extending around said feet and communicating with said main cavity through the spaces (12) between said feet, so as to define an extended cavity.

2. Construction according to claim 1, characterized in that the decoupling frame (4) has a discontinuously varying stiffness, said frame comprising a plurality of elementary decoupling frames (13) of elastically compressible foam stacked one on top of the other, the Young's modulus of said elementary frames increasing upon distancing from the plate (6) and being between 10⁴ and 10⁶ Pa.

3. Construction according to claim 1, characterized in that the decoupling frame (4) is made in one piece, said frame having a Young's modulus that increases continuously upon distancing from the plate (6), said modulus being between 10⁴ and 10⁶ Pa.

4. Construction according to claim 1, characterized in that the decoupling frame (4) is made in one piece, said frame having material recesses in the upper part of its thickness.

5. Construction according to claim 1, characterized in that the feet (8) have a relative vertical compressive stress-strain characteristic CC₄₀, measured according to ISO 3386/2 standard, greater than 10 kPa.

6. Construction according to claim 1, characterized in that the feet (8) are associated by their upper end with a support frame (14) receiving the holding frame (7).

7. Construction according to claim 1, characterized in that the feet (8) have an open porosity, so as to achieve sound absorption.

8. Construction according to claim 1, characterized in that the feet (8) are based on elastically compressible foam flakes bonded together by bi-component fibers comprising a high-temperature fusible core and a lower-temperature fusible sheath, the bond between said flakes having been achieved by melting said sheath.

9. Construction according to any of the preceding claims, claim 1, characterized in that the adjoining cavity (11) comprises a space (22) located between a mat (15) covering the vehicle floor and the pan (2), said mat being spaced from said sheet by spacer means (16) decoupled from said pan by a decoupling means (17).
